(19) United States
(12) Patent Application Publication
(10) Pub. No.: US 2020/0382552 A1
(43) Pub. Date: Dec. 3, 2020

(54) REPLAYABLE HACKTRAPS FOR INTRUDER CAPTURE WITH REDUCED IMPACT ON FALSE POSITIVES

(71) Applicant: Xinova, LLC, Seattle, WA (US)

(72) Inventor: Ezekiel KRUGLICK, Poway, CA (US)

(73) Assignee: Xinova, LLC, Seattle, WA (US)

(21) Appl. No.: 16/474,212

(22) PCT Filed: Mar. 21, 2019
(86) PCT No.: PCT/US19/23277

§ 371 Date: Jun. 27, 2019

(51) Int. Cl. H04L 29/06; G06F 9/455

(52) U.S. Cl. CPC H04L 63/1491; G06F 2009/45587; G06F 9/45558

(57) ABSTRACT

Technologies are generally described for replayable hacktraps for intruder capture with reduced impact on false positives. An example system may generate a replayable set of actions such as scripts and/or file system differences upon detecting the actions being forwarded to a deception network as potentially malicious actions. If the actions are determined not to be malicious, they may be executed on the protected network. Retroactively executing sequestered actions may allow deception countermeasures to be made more aggressive because false positive detections may have fewer negative impacts.

### BACKGROUND

Unless otherwise indicated herein, the materials described in this section are not prior art to the claims in this application and are not admitted to be prior art by inclusion in this section.

One of the state-of-the-art defenses against cyber-attacks is simulated environments. When a particular access to a protected network is determined to be likely an intrusion or a malicious action, it may be diverted to a “simulated” network that leads the attacker to believe they have gained access to the protected network. This may increase the time investment needed by attackers (hackers) and keep them engaged while countermeasures are deployed. While attackers may be confident they have successfully exploited a system, a safety layer may provide fake “stolen data” and security personnel may take counter actions.

Automated tools may provide deception-based cyber-attack protection, which may automatically place deception elements into a protected network. When attackers encounter deception elements in their critical path, those elements may create a realistic environment to detect and quarantine attackers while gathering forensic data. A potential disadvantage of deception-based protection systems is that valid users may get trapped in the deception elements or networks and spend substantial time performing tasks that are wasted.

### SUMMARY

The present disclosure generally describes techniques for replayable hacktraps for intruder capture with reduced impact on false positives.

According to some examples, an example method for implementation of replayable hacktraps for intruder capture may include detecting a potentially malicious action forwarded from a protected network to a deception network to be executed at the deception network in response to a security event; capturing the forwarded action; determining that the captured action is not malicious; and in response to the determination that the captured action is not malicious, executing the captured action at the protected network.

According to other examples, an example computing device to implement replayable hacktraps for intruder capture may include a communication device configured to communicate with a plurality of components of a protected network, a memory configured to store instructions, and a processor coupled to the communication device and the memory. The processor, in conjunction with the instructions stored on the memory, may be configured to detect a potentially malicious action forwarded from a protected network to a deception network to be executed at the deception network in response to a security event; capture the forwarded action; determine that the captured action is not malicious; and in response to the determination that the captured action is not malicious, execute the captured action at the protected network.

According to further examples, an example system configured to implement replayable hacktraps for intruder capture may include a first protected network component configured to receive actions before the actions are forwarded to other components of a protected network; and forward potentially malicious actions to a deception network. The system may also include a second protected network component configured to access events in a virtual network configured as the deception network and one or more virtual servers used for the deception; detect a potentially malicious action forwarded from the protected network to the deception network to be executed at the deception network in response to a security event; and capture the forwarded action. The system may further include a third protected network component configured to receive the captured action from the second protected network component; determine that the captured action is not malicious; and in response to the determination that the captured action is not malicious, execute the captured action at the protected network or instruct one of the first protected network component or the second protected network component to execute the captured action.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of a protected network where replayable hacktraps for intruder capture may be implemented;

FIG. 2 includes a conceptual illustration of a protected network and a deception network, to which potential intruder actions may be directed;

FIG. 3 includes a conceptual illustration of example components and interactions in direction of potential intruder actions to a deception network from a protected network;

FIG. 4 includes an illustration of an example deception hypervisor responsible for direction of potential intruder actions to a deception network from a protected network;

FIG. 5 illustrates a computing device, which may be used to manage replayable hacktraps for intruder capture with reduced impact on false positives;

FIG. 6 is a flow diagram illustrating an example method for implementation of replayable hacktraps for intruder capture with reduced impact on false positives that may be performed by a computing device such as the computing device in FIG. 5; and

FIG. 7 illustrates a block diagram of an example computer program product, some of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to replayable hacktraps for intruder capture with reduced impact on false positives.

Briefly stated, technologies are generally described for replayable hacktraps for intruder capture with reduced impact on false positives. An example system may generate a replayable set of actions such as scripts and/or file system differences upon detecting the actions being forwarded to a deception network as potentially malicious actions. If the actions are determined not to be malicious, they may be executed on the protected network. Retroactively executing sequestered actions may allow deception countermeasures to be made more aggressive because false positive detections may have fewer negative impacts.

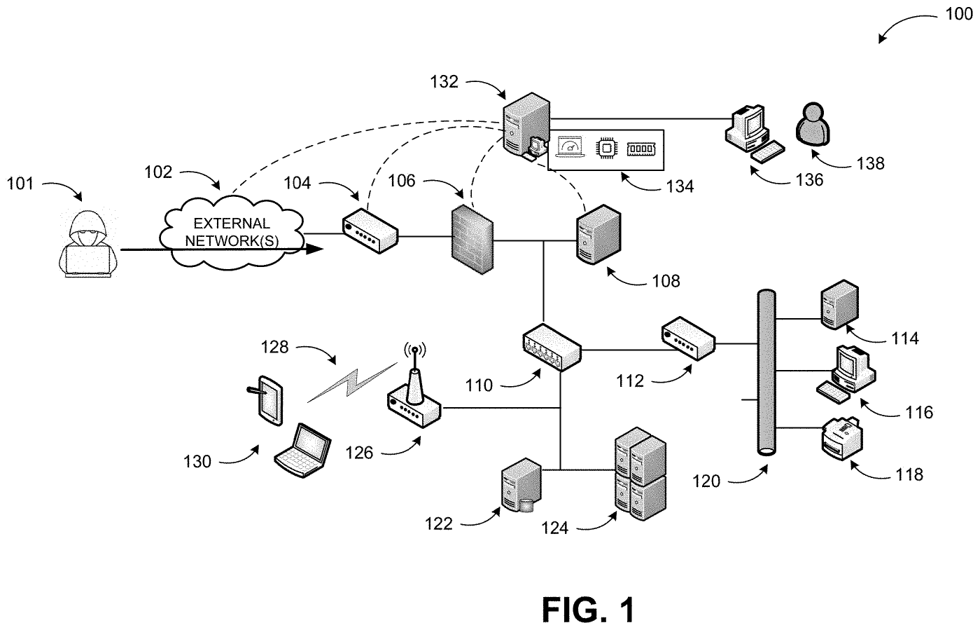

FIG. 1 includes a conceptual illustration of a protected network where replayable hacktraps for intruder capture may be implemented, in accordance with at least some embodiments described herein.

Diagram 100 shows an example protected network with example components. Networks (or computer systems) may be of any size and include a variety of types and numbers of components including sub-networks. The example protected network in diagram 100 may communicate with other networks and devices represented by external networks 102 through a switch 104. A firewall device 106 may provide first line of protection for the protected network against external attacks. The protected network may include a number of generic or special purpose components such as server 108, router 110, bridge 112, and sub-network 120. Server 114, computer 116, printer 118, and similar devices may be connected to the protected network through sub-network 120. Other example components may include server farm 124, database server 122, wireless bridge 126, and user devices 130, which may connect to the protected network wirelessly (128) through the wireless bridge 126.

An administrative server 132 may be configured to manage security operations detecting events and data exchanges through the external networks 102, switch 104, and firewall 106. The administrative server 132 may employ various threat detection tools 134 to monitor access to the protected network and identify potentially malicious actions. Detected potentially malicious actions may be forwarded to a deception network with similar properties to the protected network or a portion of the protected network to prevent intrusion to actual elements of the protected network. As some of the forwarded potentially malicious actions may not be malicious, but legitimate requests, they may be evaluated (post-forwarding) and those determined to be non-malicious may be executed on the protected network. A security operator 138 may connect to the administrative server 132 through a computing device 136 to oversee the security operations, analyze reports, and perform other tasks. For example, the security operator 138 may manually confirm legitimate actions to be executed on the protected network or oversee an automated evaluation and execution operation.

Various components of the example protected network may communicate over wired or wireless links in a number of topographic configurations. Any number of communication and security protocols may be employed for parts of or the entire protected network. Some components may be purely hardware, other components may be implemented as purely software. Yet other components may be embodied as a combination of hardware and software. The example components and configurations described herein are for illustration purposes only and are not intended to provide limitation on embodiments.

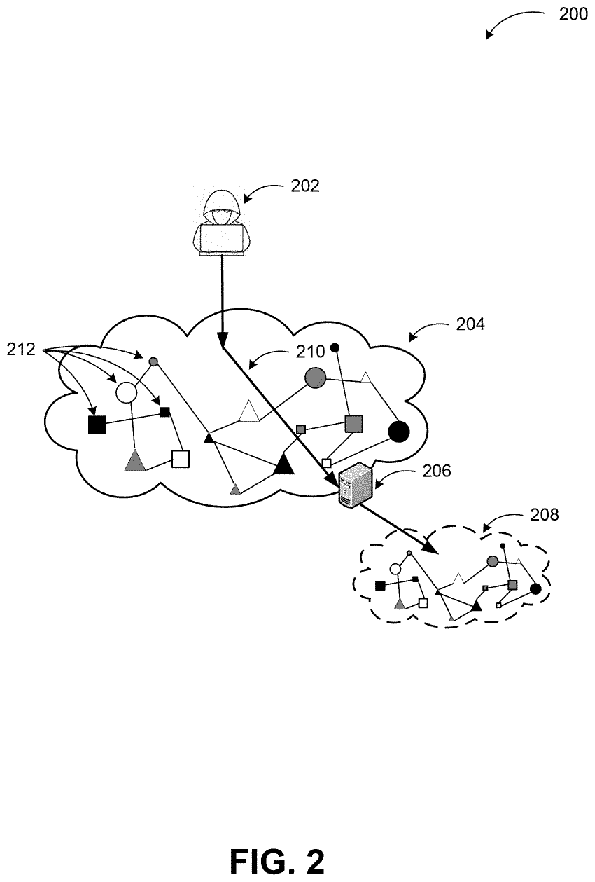

FIG. 2 includes a conceptual illustration of a protected network and a deception network, to which potential intruder actions may be directed, arranged in accordance with at least some embodiments described herein.

Diagram 200 presents an example potentially malicious action 210 (for example, an attack by an attacker 202) on protected network 204 being detected by a security server 206 and forwarded to deception network 208. Various elements 212 of the protected network 204 are represented symbolically on diagram 200.

The potentially malicious action 210 may include execution of a scriptable command, a command that may be used as part of a script or refer to a script implying a simple interpreted language without compilation, a configuration change, a file change, a change to contents or attributes of a file stored in the protected network. The malicious action may further include a kernel change, a change to one or more kernel boot parameters (text strings which are interpreted by the system to change specific behaviors and enable or disable certain features); a software installation, a credential change, a change to a user's identification, privilege, or permission levels, or a data operation, a deletion, a modification, a copying of data, or a combination thereof. The software installation may include a firmware installation, a middleware installation, and/or an application installation.

If the potentially malicious action 210 is actually part of an attack, the attack may include a denial-of-service (DoS) attack, a distributed denial-of-service (DDoS) attack, a man-in-the-middle (MitM) attack, a phishing attack, a spear phishing attack, a drive-by attack, a password attack, a sequential query language (SQL) injection attack, a cross-site scripting (XSS) attack, an eavesdropping attack, a birthday attack, or a malware attack directed to the protected network 204. These and similar attacks typically result in one or more of the potentially malicious actions described above.

Threat detection tools for monitoring potentially malicious actions may be implanted as devices, software applications, or combination thereof that monitor the protected network or its sub-systems for malicious activity or policy violations. Such tools may be classified into two groups: network intrusion detection systems (NIDS) and host-based intrusion detection systems (HIDS). Tools that monitor important operating system files are examples of HIDS, while a tool that analyzes incoming network traffic is an example of NIDS. Signature-based detection of attacks may include monitoring for specific patterns, such as byte sequences in network traffic, known malicious instruction sequences used by malware, etc. Anomaly-based detection may observe out-of-ordinary activities such as logins, requests, actions, etc. The observed activities may be compared to known patterns of normal behavior or known attacks. Monitoring tools may also include statistical tools.

Deception countermeasures may include systems that simulate networks and multiple servers, often using virtual machines and virtual network adapters to simulate dozens or hundreds of machines with their own (virtual) file systems and data. The virtual machines and adapters may be implemented on a single server, whereas large systems may use multiple servers to create convincing virtualized environments that actively model themselves on the actual protected networks and systems. More advanced systems may use look-ahead into the actual protected network to generate accurate server names and file systems. However, the more similar a deception network is to a protected network, the likelihood of false positives may increase because legitimate users' access requests may be interpreted as potentially malicious. As a result, an administrator may spend many hours adjusting scripts and updating configurations for servers that may turn out to be fake.

In some examples, a typical deception network for trapping cyber intruders may include a deception hypervisor one or more deception server(s) which maintains a virtual network mirroring properties of the actual protected network that is defended. A session suspected to be an intrusion may be routed to the virtual network so that port scans, script attempts, and any other attempted hacking actually happens within a virtual environment, where the intrusion does not damage the actual protected network and where the intrusion can be inspected. The diversion may also waste the attacker's time and reduce the impact of the attack on the protected network.

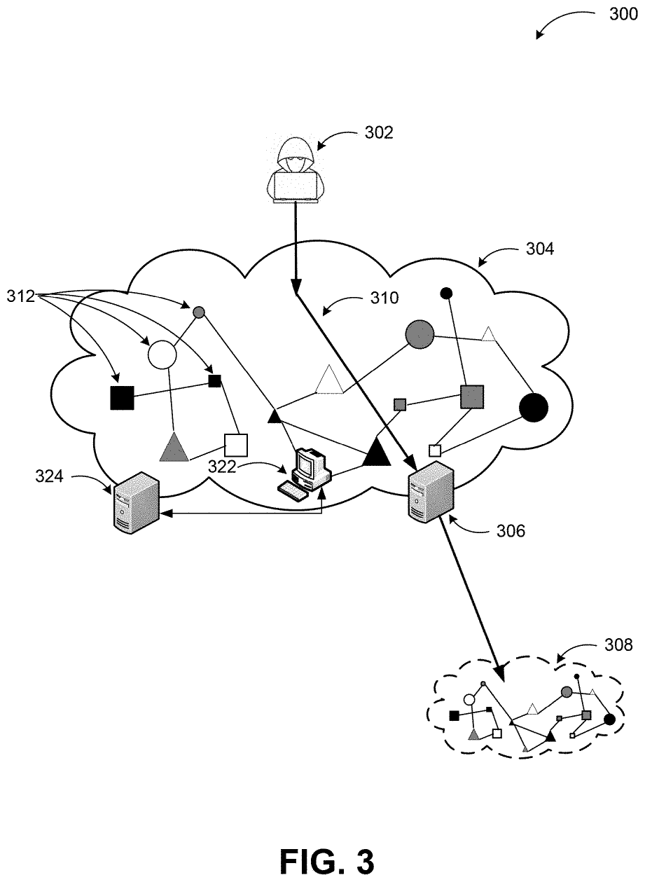

FIG. 3 includes a conceptual illustration of example components and interactions in direction of potential intruder actions to a deception network from a protected network, arranged in accordance with at least some embodiments described herein.

Diagram 300 presents an example potentially malicious action 310 (for example, an attack by an attacker 302) on protected network 304 being detected by a security server 306 and forwarded to deception network 308. Various elements 312 of the protected network 304 are represented symbolically on diagram 300. Potentially malicious action 310, in addition to being forwarded to the deception network 308, may also be analyzed (in real time or stored and analyzed subsequently) and a determination made whether the potentially malicious action 310 is actually malicious or not. The determination may be made by a security personnel (e.g., an administrator) working through computing device 322. Another security server 324 may manage recording of the captured actions and replay of those that are determined to be non-malicious. The other security server 324 and/or the computing device 322 may be components of the protected network 304 or components of another network, for example, a third-party security service.

In one example scenario, an administrator may log onto a dozen servers to check and synchronize version numbers for system libraries. For example, the administrator may need to log onto the servers used by the reports group and force the systems to use the same slightly older version of a database access library that the application group has found to be required for compatibility. In another example scenario, another administrator may need to change the default settings for ftp use, making small changes to a number of vsftp and other configuration files to allow various purposes for specific servers. In a further example scenario, yet another administrator may need to make copies of data from one server to many others, and to issue changes of ownership and characteristics on some of them. Each of these scenarios is a typical administrative task that may easily trigger behavioral intrusion detection algorithms. For example, changing ftp settings may often be a preliminary step used by hackers preparing to exfiltrate data, downgrading libraries may be used to open vulnerabilities (but is also commonly needed for compatibility), and moving data and changing ownership is performed by intruders as well. A system according to embodiments may direct the actions to a simulated network preventing further damage to the protected network from the point of detection (of the potentially malicious action). To prevent non-malicious actions such as those exemplified above from being lost to the simulated network, the system according to embodiments may record those actions and replay (i.e., execute on the protected network) upon determination that they are not malicious.

Example embodiments adopt a replayable architecture for the simulated network environment, presenting a façade that also records actions such as commands and changes. The presented architecture may allow retroactive approval of the instructions that are flagged as suspicious of potentially malicious. In turn, the ability to retroactively allow commands to be executed means that the deception counter measures may be made more aggressive because false positive detections may have fewer negative impacts. The replayable architecture may also allow aggressive detection because it provides time for security personnel to review a flagged entry and the actions taken while still preserving the work output.

The replayable deception modules according to some embodiments may record actions that are taken within them and stream the actions out to a log along with session identifier information. The recording and identification of captured sessions may provide valuable time for security personnel to inspect and review events with the ability to allow the actions to be executed on the protected network.

Action recordings may take the form of file differentials, which may be accomplished by making the virtual file system a “diff-based” system such as ZFS. When a session is retroactively authorized, the differentials may simply be added to the previous file blocks. In the rare case of a conflict, such as where someone has modified files during the time while the actions were waiting to be authorized, security personnel may review the conflicts or have automated conflict resolution rules in place. Action recordings may also take the form of scripts, which contain the series of commands that were captured and forwarded to the deception network. Both file differentials and commands may be recorded from within the virtualized network due to its virtualized nature.

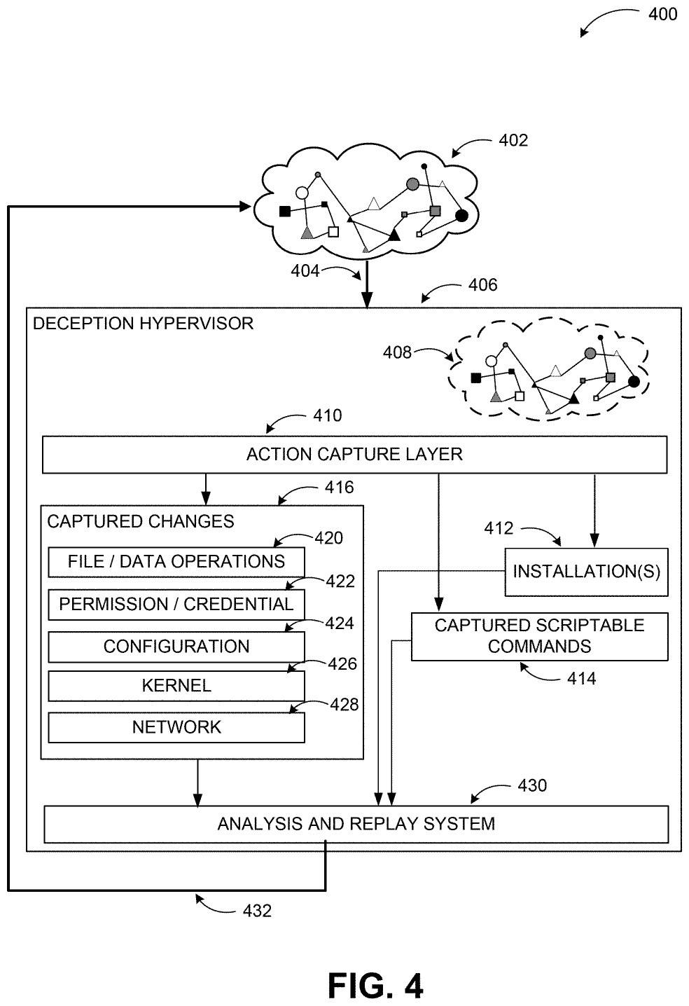

FIG. 4 includes an illustration of an example deception hypervisor responsible for direction of potential intruder actions to a deception network from a protected network, arranged in accordance with at least some embodiments described herein.

Diagram 400 shows an architectural overview of a system according to embodiments and includes a deception hypervisor 406 to manage operations of a deception network 408 configured to receive captured and forwarded potentially malicious actions 404 from a protected network 402. The deception hypervisor 406 may have hypervisor access to all events in the virtual network and virtual servers of the deception network 408. The deception hypervisor 406 may include an action capture layer 410 to capture potentially malicious actions. The action capture layer 410 may capture installations 412 of software, firmware, middleware, and similar ones. The action capture layer 410 may also capture scriptable commands 414 and changes 416. The captured changes 416 may include file or data operations 420, permission or credential changes 422, configuration changes 424, kernel changes 426, and network changes 428, among others.

The captured installations 412, scriptable commands 414, and changes 416 may not be immediately reflected in the protected network 402. Instead they may be stored and analyzed later. The analysis and replay system 430 may receive the captured installations 412, scriptable commands 414, and changes 416 from the action capture layer 410 and allow the security personnel to review the captured actions. The security personnel may remove the captured actions, keep them solely in the virtual network, or approve them for replay on the protected network. Actions 432 determined to be non-malicious and allowed for replay may be enacted in the protected network 402 by the analysis and replay system 430.

The flexibility of analyzing and allowing captured actions to be executed on the protected network later may allow security personnel with even limited authority to perform intrusion prevention actions and then receive approval later if the suspected actions trigger a security quarantine. Meanwhile, a security team may gain valuable time to consider events and less pressure over false detections, allowing their security triggers to be set more conservatively.

In some examples, a deception network may include a virtual network that mirrors one or more properties of the protected network. The potentially malicious action may be captured at the protected network or at the deception network. In some cases, the deception network may be an isolated part of the protected network. The potentially malicious action may be captured through one or more of paravirtualizing one or more processes associated with the forwarded action, hooking one or more processes associated with the forwarded action, or generating an instrumented operating system image.

Capturing the forwarded action may include capturing one or more of a scriptable command, a configuration change, a file change, a data operation, a kernel change, a software installation, a network change, or a credential change. The data operation may include one or more of a deletion, a modification, or a copying of data. The software installation may include one or more of a firmware installation, a middleware installation, or an application installation. The credential change may be a privilege or permission level change.

In other examples, the captured action may be stored at the protected network or the deception network. The determination of whether the captured action is malicious or not may be made based on analyzing the captured action or receiving input from an administrator or user. For example, a user whose attempted credential change is stopped or not executed at the protected network may notify an administrator and confirm that the change is legitimate. Massive data operations (e.g., deletion or copying) may be stopped and the nature of the operation analyzed. If the data operation is legitimate (e.g., moving data between servers, changing user accounts, etc.), the stopped operation may be allowed to proceed. The captured action may be executed automatically by a security system at the protected network upon determination that the action is not malicious. Alternatively, instructions to execute the captured action manually at the protected network may be transmitted to an administrator from the security system.

As discussed above, the potentially malicious action forwarded from the protected network to the deception network may be detected and captured by a deception hypervisor with access to events in a virtual network configured as the deception network and one or more virtual servers used for the deception. The determination that the captured action is not malicious may be performed and the captured action may be executed at the protected network by an analysis and replay system of the deception hypervisor. Detection, capture, and forwarding of the potentially malicious action to the deception network may be performed by a computing device (e.g., a server) that is a component of the protected network or is outside of the protected network. For example, the computing device may be a server of a third-party security system. In either scenario, the computing device may be arranged to intercept the potentially malicious action before it is disseminated to other components of the protected network. The computing device may be a server, a router, a firewall device, a desktop computer, a vehicle mount computer, a laptop computer, or a special purpose network device.

As there is bound to be a delay between the potentially malicious action arriving at the protected network and being executed upon confirmation that it is not malicious, conflicts may arise due to changes in system configuration, data, application states, etc. in the meantime. Such conflicts may be resolved through a number of conflict resolution techniques. For example, a tree may be built applying commands to both the unmodified and modified environments, and then a tree leaf may be selected (for the unmodified environment) based on which events are found to be valid.

In some cases, it may be advantageous to have different types of command line actions preserved in different ways, such as preserving changes to text configuration files as file differentials and preserving installation commands as scripts. Such mappings or rule-sets may depend on the configuration of the deception units and how well they mirror the actual systems, and such mappings or rule-sets may be configured in some cases by the security system during installation depending on which options are selected for the deception measures.

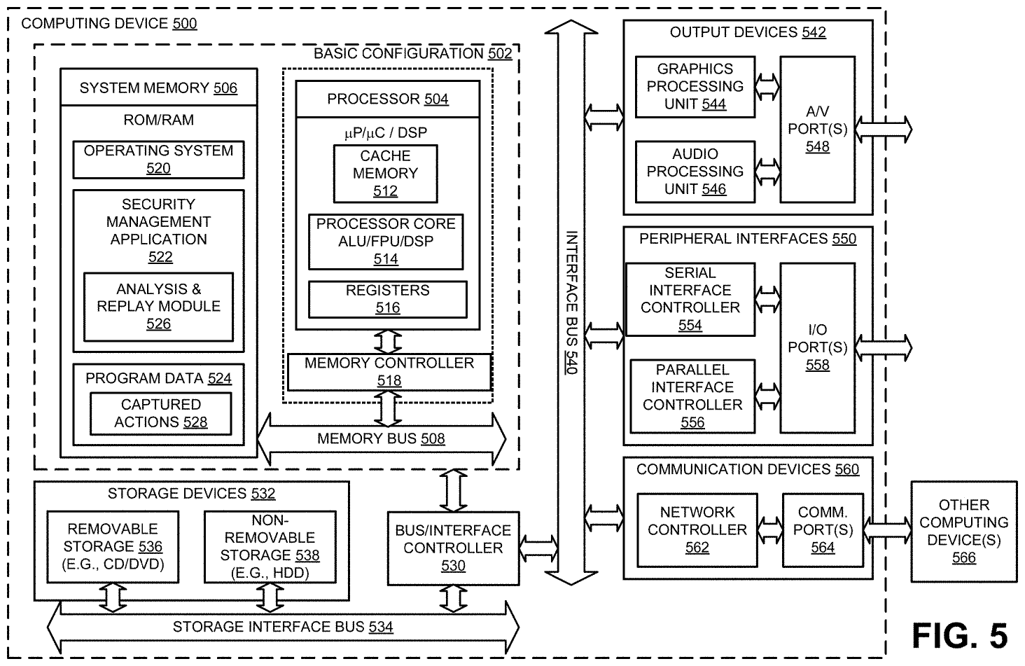

FIG. 5 illustrates a computing device, which may be used to manage replayable hacktraps for intruder capture with reduced impact on false positives, arranged in accordance with at least some embodiments described herein.

In an example basic configuration 502, the computing device 500 may include one or more processors 504 and a system memory 506. A memory bus 508 may be used to communicate between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one or more levels of caching, such as a cache memory 512, a processor core 514, and registers 516. The example processor core 514 may include an arithmetic logic unit (ALU), a floating point unit (FPU), a digital signal processing core (DSP core), or any combination thereof. An example memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a security management application 522, and program data 524. The security management application 522 may include an analysis and replay module 526. The analysis and replay module 526, in conjunction with the security management application 522 may be configured to detect a potentially malicious action forwarded from a protected network to a deception network to be executed at the deception network in response to a security event, capture the forwarded action, determine that the captured action is not malicious, and execute the captured action at the protected network in response to the determination that the captured action is not malicious. The program data 524 may include captured action data 528, among other data, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Examples of computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 550, and one or more communication devices 560) to the basic configuration 502 via the bus/interface controller 530. Some of the example output devices 542 include a graphics processing unit 544 and an audio processing unit 546, which may be configured to communicate to various external devices such as a display or speakers via one or more A/V ports 548. One or more example peripheral interfaces 550 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 560 includes a network controller 562, which may be arranged to facilitate communications with one or more other computing devices 566 over a network communication link via one or more communication ports 564. The one or more other computing devices 566 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 500 may be implemented as a part of a specialized server, mainframe, or similar computer that includes any of the above functions. The computing device 500 may also be implemented as a personal computer including both laptop computer and non-laptop computer configurations.

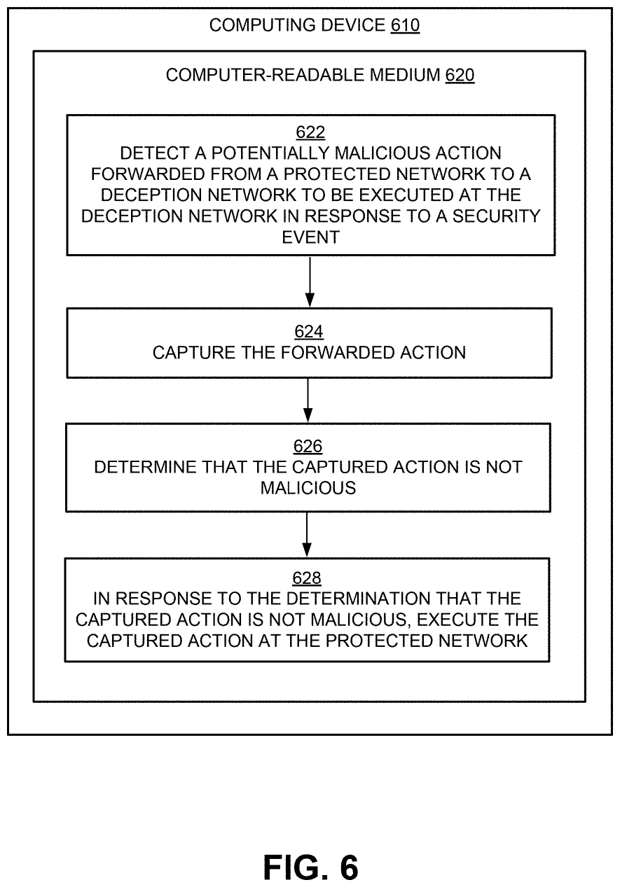

FIG. 6 is a flow diagram illustrating an example method for implementation of replayable hacktraps for intruder capture with reduced impact on false positives that may be performed by a computing device such as the computing device in FIG. 5, arranged in accordance with at least some embodiments described herein.

Example methods may include one or more operations, functions, or actions as illustrated by one or more of blocks 622, 624, 626, and 628 may in some embodiments be performed by a computing device such as the computing device 500 in FIG. 5. Such operations, functions, or actions in FIG. 6 and in the other figures, in some embodiments, may be combined, eliminated, modified, and/or supplemented with other operations, functions or actions, and need not necessarily be performed in the exact sequence as shown. The operations described in the blocks 622-628 may be implemented through execution of computer-executable instructions stored in a computer-readable medium such as a computer-readable medium 620 of a computing device 610.

An example process for replayable hacktraps for intruder capture with reduced impact on false positives may begin with block 622, “DETECT A POTENTIALLY MALICIOUS ACTION FORWARDED FROM A PROTECTED NETWORK TO A DECEPTION NETWORK TO BE EXECUTED AT THE DECEPTION NETWORK IN RESPONSE TO A SECURITY EVENT”, where an action such as a scriptable command, a configuration change, a file change, a data operation, a kernel change, a software installation, a network change, or a credential change may be captured at a protected network as potentially malicious and forwarded to a deception network that mirrors properties of the protected network. The data operation may include one or more of a deletion, a modification, or a copying of data. The software installation may include one or more of a firmware installation, a middleware installation, or an application installation. The credential change may be a privilege or permission level change.

Block 622 may be followed by block 624, “CAPTURE THE FORWARDED ACTION”, where the forwarded action may be recorded for analysis and potential replay on the protected network if the action is found to be non-malicious by the analysis.

Block 624 may be followed by block 626, “DETERMINE THAT THE CAPTURED ACTION IS NOT MALICIOUS”, where a security personnel or an automated security system may analyze the action and determine not to be malicious. For example, a user logging in to the protected network from an unusual location or requesting an unusual data operation may be determined to be non-malicious upon confirmation by the user.

Block 626 may be followed by block 628, “IN RESPONSE TO THE DETERMINATION THAT THE CAPTURED ACTION IS NOT MALICIOUS, EXECUTE THE CAPTURED ACTION AT THE PROTECTED NETWORK”, where the recorded action may be executed on the protected network upon confirmation that the action is non-malicious. Any conflicts may be resolved through a number of conflict resolution techniques.

The operations included in the process described above are for illustration purposes. Replayable hacktraps for intruder capture with reduced impact on false positives may be implemented by similar processes with fewer or additional operations, as well as in different order of operations using the principles described herein. The operations described herein may be executed by one or more processors operated on one or more computing devices, one or more processor cores, and/or specialized processing devices, among other examples.

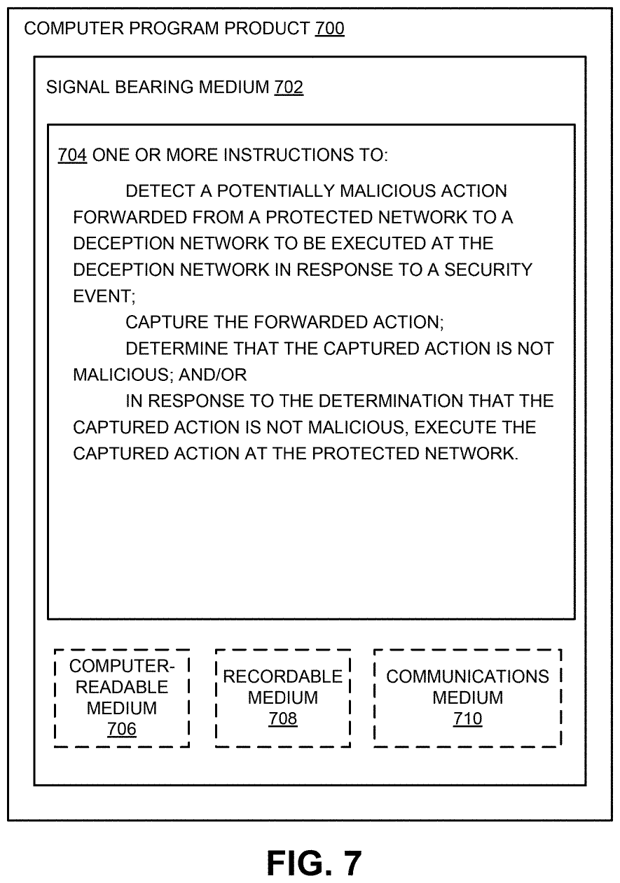

FIG. 7 illustrates a block diagram of an example computer program product, arranged in accordance with at least some embodiments described herein.

In some examples, as shown in FIG. 7, a computer program product 700 may include a signal bearing medium 702 that may also include one or more machine readable instructions 704 that, in response to execution by, for example, a processor may provide the functionality described herein. Thus, for example, referring to the processor 504 in FIG. 5, the security management application 522 may perform or control performance of one or more of the tasks shown in FIG. 7 in response to the instructions 704 conveyed to the processor 504 by the signal bearing medium 702 to perform actions associated with the control and implementation of replayable hacktraps for intruder capture with reduced impact on false positives as described herein. Some of those instructions may include, for example, detect a potentially malicious action forwarded from a protected network to a deception network to be executed at the deception network in response to a security event; capture the forwarded action; determine that the captured action is not malicious; and/or in response to the determination that the captured action is not malicious, execute the captured action at the protected network, according to some embodiments described herein.

In some implementations, the signal bearing medium 702 depicted in FIG. 7 may encompass computer-readable medium 706, such as, but not limited to, a hard disk drive (HDD), a solid state drive (SSD), a compact disc (CD), a digital versatile disk (DVD), a digital tape, memory, and comparable non-transitory computer-readable storage media. In some implementations, the signal bearing medium 702 may encompass recordable medium 708, such as, but not limited to, memory, read/write (R/W) CDs, R/W DVDs, etc. In some implementations, the signal bearing medium 702 may encompass communications medium 710, such as, but not limited to, a digital and/or an analog communication medium (e.g., a fiber optic cable, a waveguide, a wired communication link, a wireless communication link, etc.). Thus, for example, the computer program product 700 may be conveyed to one or more modules of the processor 504 by an RF signal bearing medium, where the signal bearing medium 702 is conveyed by the communications medium 710 (e.g., a wireless communications medium conforming with the IEEE 802.11 standard).

According to some examples, an example method for implementation of replayable hacktraps for intruder capture may include detecting a potentially malicious action forwarded from a protected network to a deception network to be executed at the deception network in response to a security event; capturing the forwarded action; determining that the captured action is not malicious; and in response to the determination that the captured action is not malicious, executing the captured action at the protected network.

According to other examples, detecting the potentially malicious action forwarded from the protected network to the deception network may include detecting forwarding of the potentially malicious action to a virtual network that mirrors one or more properties of the protected network. Capturing the forwarded action may include one or more of paravirtualizing one or more processes associated with the forwarded action; hooking one or more processes associated with the forwarded action; or executing an instrumented operating system image.

According to other examples, capturing the forwarded action may include capturing one or more of a scriptable command, a configuration change, a file change, a data operation, a kernel change, a software installation, a network change, or a credential change. Capturing the data operation may include capturing one or more of a deletion, a modification, or a copying of data at the deception network. Capturing the software installation may include capturing one or more of a firmware installation, a middleware installation, or an application installation at the deception network. Capturing the credential change may include capturing a privilege change.

According to further examples, the method may also include storing the captured action. The method may further include analyzing the captured action; and determining whether the captured action is malicious or not. The method may also include receiving information associated with the determination that the captured action is not malicious. Executing the action at the protected network in response to the determination that the captured action is not malicious may include automatically executing the captured action at the protected network. Executing the action at the protected network in response to the determination that the captured action is not malicious may also include providing an instruction to execute the captured action manually at the protected network.

According to other examples, an example computing device to implement replayable hacktraps for intruder capture may include a communication device configured to communicate with a plurality of components of a protected network, a memory configured to store instructions, and a processor coupled to the communication device and the memory. The processor, in conjunction with the instructions stored on the memory, may be configured to detect a potentially malicious action forwarded from a protected network to a deception network to be executed at the deception network in response to a security event; capture the forwarded action; determine that the captured action is not malicious; and in response to the determination that the captured action is not malicious, execute the captured action at the protected network.

According to further examples, the processor may be configured to detect the potentially malicious action forwarded from the protected network to the deception network through detection of forwarding of the potentially malicious action to a virtual network that mirrors one or more properties of the protected network. The processor may be configured to capture the forwarded action through one or more of paravirtualization of one or more processes associated with the forwarded action; hooking of one or more processes associated with the forwarded action; or execution of an instrumented operating system image. The processor may be configured to capture one or more of a scriptable command, a configuration change, a file change, a data operation, a kernel change, a software installation, a network change, or a credential change as the captured action.

According to some examples, the data operation may include one or more of a deletion, a modification, or a copying of data at the deception network. The software installation may include one or more of a firmware installation, a middleware installation, or an application installation at the deception network. The processor may be further configured to store the captured action. The processor may also be configured to analyze the captured action; and determine whether the captured action is malicious or not. The processor may be further configured to receive information associated with the determination that the captured action is not malicious. The processor may be configured to execute the action automatically at the protected network in response to the determination that the captured action is not malicious.

According to other examples, the processor may be configured to provide an instruction to execute the captured action manually at the protected network in response to the determination that the captured action is not malicious. The potentially malicious action forwarded from the protected network to the deception network may be detected and captured by a deception hypervisor with access to events in a virtual network configured as the deception network and one or more virtual servers used for the deception. The determination that the captured action is not malicious may be performed and the captured action may be executed at the protected network by an analysis and replay system of the deception hypervisor. The computing device may be a component of the protected network that receives actions before the actions are forwarded to other components of the protected network. The computing device may be a server outside of the protected network. The computing device may also be a server of a third party security system.

According to further examples, an example system configured to implement replayable hacktraps for intruder capture may include a first protected network component configured to receive actions before the actions are forwarded to other components of a protected network; and forward potentially malicious actions to a deception network. The system may also include a second protected network component configured to access events in a virtual network configured as the deception network and one or more virtual servers used for the deception; detect a potentially malicious action forwarded from the protected network to the deception network to be executed at the deception network in response to a security event; and capture the forwarded action. The system may further include a third protected network component configured to receive the captured action from the second protected network component; determine that the captured action is not malicious; and in response to the determination that the captured action is not malicious, execute the captured action at the protected network or instruct one of the first protected network component or the second protected network component to execute the captured action.

According to some examples, the virtual network may mirror one or more properties of the protected network. The second protected network component may be configured to capture the forwarded action through one or more of paravirtualization of one or more processes associated with the forwarded action; hooking of one or more processes associated with the forwarded action; or execution of an instrumented operating system image. The captured action may be one or more of a scriptable command, a configuration change, a file change, a data operation, a kernel change, a software installation, a network change, or a credential change. The data operation may include one or more of a deletion, a modification, or a copying of data at the deception network. The software installation may include one or more of a firmware installation, a middleware installation, or an application installation at the deception network.

According to other examples, the second protected network component may be further configured to store the captured action. The second protected network component or the third protected network component may be further configured to analyze the captured action; and determine whether the captured action is malicious or not. The third protected network component may be configured to execute the action automatically at the protected network in response to the determination that the captured action is not malicious. The first protected network component, the second protected network component, or the third protected network component may be a server, a router, a firewall device, a desktop computer, a vehicle mount computer, a laptop computer, or a special purpose network device.

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method for implementation of replayable hacktraps for intruder capture, the method comprising:
detecting a potentially malicious action forwarded from a protected network to a deception network to be executed at the deception network in response to a security event;
capturing the forwarded action;
determining that the captured action is not malicious; and
in response to the determination that the captured action is not malicious, executing the captured action at the protected network.

2. The method of claim 1, wherein detecting the potentially malicious action forwarded from the protected network to the deception network comprises:
detecting forwarding of the potentially malicious action to a virtual network that mirrors one or more properties of the protected network.

3. (canceled)

4. The method of claim 1, wherein capturing the forwarded action comprises:
capturing one or more of a scriptable command, a configuration change, a file change, a data operation, a kernel change, a software installation, a network change, or a credential change.

5. The method of claim 1, wherein capturing the forwarded action comprises:
capturing a data operation at the deception network for one or more of a deletion operation, a modification operation, or a copying of data operation.

6. The method of claim 1, wherein capturing the forwarded action comprises:
capturing a software installation at the deception network for one or more of a firmware installation, a middleware installation, or an application installation.

7. The method of claim 4, wherein capturing the credential change comprises:
capturing a privilege change.

8. The method of claim 1, further comprising:
storing the captured action.

9. The method of claim 1, further comprising:
analyzing the captured action; and
determining whether the captured action is malicious or not.

10. The method of claim 1, further comprising:
receiving information associated with the determination that the captured action is not malicious.

11. The method of claim 1, wherein executing the action at the protected network in response to the determination that the captured action is not malicious comprises:
automatically executing the captured action at the protected network.

12. The method of claim 1, wherein executing the action at the protected network in response to the determination that the captured action is not malicious comprises:
providing an instruction to execute the captured action manually at the protected network.

13. A computing device to implement replayable hacktraps for intruder capture, the computing device comprising:
a communication device configured to communicate with a plurality of components of a protected network;
a memory configured to store instructions; and
a processor coupled to the communication device and the memory, wherein the processor in conjunction with the instructions stored on the memory is configured to:
detect a potentially malicious action forwarded from a protected network to a deception network to be executed at the deception network in response to a security event;
capture the forwarded action;
determine that the captured action is not malicious; and
in response to the determination that the captured action is not malicious, execute the captured action at the protected network.

14. The computing device of claim 13, wherein the processor is configured to detect the potentially malicious action forwarded from the protected network to the deception network through detection of forwarding of the potentially malicious action to a virtual network that mirrors one or more properties of the protected network.

15. (canceled)

16. The computing device of claim 13, wherein the processor is configured to capture one or more of a scriptable command, a configuration change, a file change, a data operation, a kernel change, a software installation, a network change, or a credential change as the captured action.

17. The computing device of claim 13, wherein the processor is configured to capture a data operation or a software installation,
wherein the data operation comprises one or more of a deletion, a modification, or a copying of data at the deception network; and
wherein the software installation comprises one or more of a firmware installation, a middleware installation, or an application installation at the deception network.

18. (canceled)

19. (canceled)

20. The computing device of claim 13, wherein the processor is configured to determine that the captured action is not malicious by one or more of an analysis of the captured action or receipt of information that indicates the captured action is not malicious.

21. (canceled)

22. The computing device of claim 13, wherein the processor is configured to:
execute the action automatically at the protected network in response to the determination that the captured action is not malicious; or
provide an instruction to execute the captured action manually at the protected network in response to the determination that the captured action is not malicious.

23. (canceled)

24. The computing device of claim 13, wherein the processor is further configured to detect and capture the potentially malicious action forwarded from the protected network with a deception hypervisor with access to events in a virtual network, wherein the virtual network is configured as the deception network and one or more virtual servers are used for the deception.

25. (canceled)

26. The computing device of claim 13, wherein the computing device is a component of the protected network that receives actions before the actions are forwarded to other components of the protected network, a server outside of the protected network, or a server of a third party security system.

27. (canceled)

28. (canceled)

29. A system configured to implement replayable hacktraps for intruder capture, the system comprising:
a first protected network component configured to:
receive actions before the actions are forwarded to other components of a protected network; and
forward potentially malicious actions to a deception network;
a second protected network component configured to:
access events in a virtual network configured as the deception network and one or more virtual servers used for the deception;
detect a potentially malicious action forwarded from the protected network to the deception network to be executed at the deception network in response to a security event; and
capture the forwarded action; and
a third protected network component configured to:
receive the captured action from the second protected network component;
determine that the captured action is not malicious; and
in response to the determination that the captured action is not malicious, execute the captured action at the protected network.

30. The system of claim 29, wherein the virtual network is configured to mirror one or more properties of the protected network.

31. The system of claim 29, wherein the second protected network component is configured to capture the forwarded action through one or more of:
paravirtualization of one or more processes associated with the forwarded action;
hooking of one or more processes associated with the forwarded action; or
execution of an instrumented operating system image.

32. The system of claim 29, wherein the second network component is configured to capture one or more of a scriptable command, a configuration change, a file change, a data operation, a kernel change, a software installation, a network change, or a credential change.

33. The system of claim 32, wherein the second network component is configured to capture a data operation or a software installation,
wherein the data operation comprises one or more of a deletion, a modification, or a copying of data at the deception network; and
wherein the software installation comprises one or more of a firmware installation, a middleware installation, or an application installation at the deception network.

34. (canceled)

35. The system of claim 29, wherein the second protected network component is further configured to:
store the captured action.

36. The system of claim 29, wherein the second protected network component or the third protected network component is further configured to:
analyze the captured action; and
determine whether the captured action is malicious or not.

37. The system of claim 29, wherein the third protected network component is configured to:
execute the action automatically at the protected network in response to the determination that the captured action is not malicious.

38. The system of claim 29, wherein the first protected network component, the second protected network component, or the third protected network component are one of: a server, a router, a firewall device, a desktop computer, a vehicle mount computer, a laptop computer, and a special purpose network device.
